(19) United States
(12) Patent Application Publication
(10) Pub. No.: US 2012/0053958 A1
(43) Pub. Date: Mar. 1, 2012

(54) System and Methods for Providing Incentives for Health Care Providers

(76) Inventors: Charles Marshall, Atherton, CA (US); Paul Spaeth, Half Moon Bay, CA (US)

(21) Appl. No.: 13/218,882

(22) Filed: Aug. 26, 2011

Related U.S. Application Data
(60) Provisional application No. 61/377,600, filed on Aug. 27, 2010.

(51) Int. Cl. G06Q 50/22

(52) U.S. Cl. 705/2

(57) ABSTRACT

A system and method is disclosed whereby a health care provider is offered a benefit in exchange for the performance of specified activities of a patient. The patient activities may take the form of a purchase of prescribed or recommended products or services, such as prescription drugs, undergoing prescribed or recommended health care procedures, or participation in health-oriented programs or activities, such as a specified exercise regimen. In one embodiment, a benefit is provided to a health care provider upon verification of the adherence of a patient to a specified health-related activity. In one embodiment a benefit is provided to both a provider and a patient upon verification of the patient's adherence to a specified health-related activity. In one embodiment, patient adherence is facilitated by distributing benefit cards to patients wherein the benefit card identifies the patient as registered in an adherence program and is associated with a benefit account for receiving program benefits. In one embodiment, the benefit card account is associated with the patient's health or prescription insurance account so as to verify adherence using claims submitted to the patient's health insurer. In one embodiment, the benefit card operates as a payment card allowing the cardholder to redeem benefits.

### CROSS-REFERENCE TO RELATED APPLICATION

This Application claims the benefit of and priority to U.S. Provisional Patent Application Ser. No. 61/377,600, filed Aug. 27, 2010, which is incorporated herein by reference for all purposes.

### FIELD OF THE INVENTION

The present invention relates to providing a system and methods for providing incentives to health care providers for adherence of their patients to heath care activities.

### BACKGROUND

The problem of poor patient adherence to health care treatment is a well-recognized problem in the United States. Some estimates show that non-adherence to medications causes 125,000 deaths annually in this country and accounts for 10% to 25% of hospital and nursing home admissions. This makes non-adherence to medications one of the largest and most expensive disease categories. Moreover, patient non-adherence is not limited to medications alone. It can also take many other forms; these include the failure to keep appointments, to follow recommended dietary or other lifestyle changes, and to follow other aspects of treatment or recommended preventive health practices, such as engaging in clinical trials. Hence, the actual implications of non-adherence go far beyond the financial aspect of medication non-adherence.

Various methods have been used by pharmaceutical companies, hospitals, health care providers, government agencies and nonprofit organizations to incent and promote greater patient adherence. The vast majority of these programs focus on providing incentive benefits, such as discounts, rebates, subsidized co-payments or free samples, to patients in order to induce their adherence to filling or refilling a prescription medicine, receiving preventative treatment, or following a recommended dietary or exercise regimen. Some provider programs offer incentive benefits to providers, such as, for example, the 2006 Tax Relief and Health Care Act (TRHCA) (P.L. 109-432), which requires the establishment of a physician quality reporting system, including an incentive payment for eligible professionals who satisfactorily report data on quality measures for covered professional services furnished to Medicare beneficiaries. However, the provider incentive programs prevailing in the existing art do not link the provider incentive benefits to verified adherence of their patients to health care activities.

One of the problems with these approaches to alleviating non-adherence is that they fail to recognize the influential role of health care providers in affecting patient attitudes and behaviors towards adherence. In particular, current methods of incentivizing patient adherence do not offer benefits to health care providers who become actively engaged in facilitating patient adherence. As trusted advisors, health care providers often have a major influence on the adherence behavior of patients. Systems and methods that reward providers, either individually or in incentive programs that combine both providers and patients, with monetary benefits for patient adherence will significantly vary the approaches to promoting patient compliance with prescribed or recommended health care activities and alleviate the problems inherent in the prior art.

### SUMMARY OF THE INVENTION

Some embodiments are directed to particular features of a system and method of providing incentives for health care providers in order to encourage their involvement in influencing patients to perform specified health-related activities. Some embodiments include a system, method and apparatus for providing incentive benefits to health care providers whereby the provider receives a benefit conditioned upon the demonstrated adherence of their patients to activities specified in an incentive program. In one embodiment, incentive benefits may be provided by program sponsors such as, for example, product manufacturers, health insurers, retailers, government bodies or non-profits. Program sponsors offer these incentive benefits in order to motivate providers to influence the behavior of their patients towards conducting a specified activity, performance of which benefits not only the patient, but also the sponsoring entity. Examples of such activities may include, for example, the purchase, filling or refilling of a particular product such as a prescription or OTC drug, undergoing a health care procedure such as a cancer screening, or engaging in a particular health-related activity such as a daily exercise regimen. In one embodiment, the provider enrolls in the incentive program by registering with a program administrator and designating patients for whose activities the provider will be eligible to receive benefits in accordance with a previously defined incentive program.

According to some embodiments of the present invention, a system, method and apparatus for enabling program sponsors to offer incentive benefits to both provider and patients enables program sponsors to separately offer incentives that attract participation of both providers and patients in programs linked to patient behavior. In one embodiment, a program sponsor establishes a program to provide financial benefits to both a provider and a patient when a patient completes a prescribed adherence activity, such as filling a prescription. Both the patient and the provider enroll in the program and upon the completion of the activity both participants receive the incentive award as defined by the program.

In some embodiments of the present invention provides a system, method and apparatus that allows incentive beneficiaries to receive a benefit card associated with a benefit account wherein the card both identifies the cardholder as a participant in an incentive program for purposes of adherence activity verification and serves as a payment mechanism for redeeming benefits from benefit accounts. In various embodiments, the card may be issued by a health care provider, a program administrator or a program sponsor, to either an eligible provider, an eligible patient, or both. A separate benefits account is established for each card issued and benefit amounts in each account are updated as patients meet the criteria established under an incentive benefits program. The payment card can then be used to redeem the benefits at merchant or other establishments that accept the payment card. In some embodiments redemption of the benefits may be restricted to certain types of purchases, such as health care-related products or services, or to certain merchant establishments.

### BRIEF DESCRIPTION OF THE DRAWINGS

FIG. 1 is a block diagram depicting an overview of a process for providing incentives benefits for patient adherence in accordance with one embodiment of the present invention.

FIG. 2 is a flow diagram illustrating a general method for providing incentive benefits to providers for adherence of patients to specified health care activities in accordance with one embodiment of the present invention.

FIG. 3 is a flow diagram illustrating a method for providing incentive benefits to providers and patients for patient adherence to prescription fulfillment or receiving specified health care procedures in accordance with one embodiment of the present invention.

FIG. 4 is a tabular representation of exemplary incentive programs that may be offered by program sponsors to providers and patients for patient adherence to prescription fulfillment or receiving specified health care procedures in accordance with one embodiment of the present invention.

FIG. 5 is a tabular representation of an exemplary registration to a program offering incentive benefits to providers and patients for patient adherence to prescription fulfillment or receiving specified health care procedures in accordance with one embodiment of the present invention.

FIG. 6 is a tabular representation of an exemplary insurance claim used to verify an adherence activity in accordance with one embodiment of the present invention.

FIG. 7 is a flow diagram depicting a method of facilitating verification of an adherence activity using an insurance claim.

FIG. 8 is a block diagram of an embodiment of a system for implementing the present invention.

### DETAILED DESCRIPTION

In various embodiments of the present invention, the process of providing patient adherence incentives and benefits to providers, either individually or in programs that combine incentives for both providers and patients involves the implementation of an incentive program such as, according to our example, awarding a benefit to a health care provider for the purchase of a prescribed medicine by a patient. Under various embodiments, benefits may be offered and funded by incentive program sponsors. For example, a pharmacy benefits manager may seek to sponsor a benefit that incents providers to help induce more of their patients to fill prescriptions. The benefit may be a monetary amount awarded to the provider for each prescription filled by patients that are registered under the program. Such a program may encourage the provider to take active steps towards persuading the patient to fill the prescription, such as, for example, assisting with online drug purchases, follow up telephone calls, email reminders, or the like. Another example is a health plan that may wish to offer a reward to a health care provider whose patients successfully complete a cancer screening or take disease prevention steps, such as smoking cessation. A further example is a government agency, such as the National Institute of Health, which seeks to encourage patient participation in clinical trials for testing new forms of drugs or therapy. A rewards program that offers incentives to providers to recruit eligible patients into the trial and monitor their adherence to the trial requirements can result in more effective and accurate evaluations of therapies. In some embodiments, the health care provider, in cooperation with a sponsor, may play an active role in structuring and defining the activities, incentives, and benefits of a program.

For the purposes of describing features of embodiments of the present invention, a number of terms are used herein. Pursuant to some embodiments, benefits may include any denomination of rewards, loyalty value, loyalty points, discounts, rebates, dollars, foreign currencies, coupons, gift certificates, bonus points, credits or debits to a financial instrument, and/or the like

As used herein, the term “product” is used to refer to one or more physical products or goods as well as services.

As used herein, the term “merchant” means any person, entity, distributor system, software, and/or hardware that is a provider, broker, and/or any other entity in the distribution chain of goods and services. For example, a merchant may be a financial institution, a hotel chain, an airline, a grocery store, a retail store, a pharmacy, a health care provider, an online merchant, or the like.

As used herein, an “account”, “account number” or “account code” may include any device, code, number, letter, symbol, digital certificate, smart chip, digital signal, analog signal, biometric or other identifier/indicia suitably configured to allow a consumer, a patient, a provider, a card issuer, an employer, an insurer, or the like, to access, interact with or communicate with the adherence incentive system described herein.

As used herein, a “patient” may include any individual or group of individuals receiving a prescribed or recommended activity by a health care provider in the course of a single encounter with the health care provider or in multiple encounters with a health care provider as part of an episode of care. Patients, as used herein, may be insured by an insurer or uninsured. The party insured by an insurer may be an insurance policy holder, or a party covered by another's insurance policy, such as a dependent of an insured party.

As used herein, “health care provider” refers to any qualified person who delivers proper health care in a systematic way professionally to any individual or individuals in need of health care services. Health care providers may include, for example, health professionals, physicians, dentists, specialists, nurses, optometrists, ophthalmologists, pharmacists, psychologists, psychiatrists, chiropractics, or the like. Health care providers may operate individually or as part of an organization that provides services of health professionals, such as, for example, PPO networks, physician practice groups, managed care organizations, or the like.

As used herein, “adherence activity” refers to any steps or treatments prescribed, specified or recommended to a patient by a health care provider in the course of a patient's encounter with the provider, including either therapeutic or preventative treatments or a combination of therapeutic and preventative treatments. Adherence activities refers to both medical and non-medical treatments and may include the patient undertaking or agreeing to undertake a test, procedure or a physical examination; the filling, purchase, consumption or application of a prescribed or non-prescribed drug or pharmaceutical product; adopting a one-time or continuous maintenance program to prevent a future condition or injury; refraining from one or more hazardous activities, such as smoking, speeding or consuming alcohol or drugs; or adhering to a physical or exercise program. According to some embodiments, adherence activities recommended to patients may be based on accepted practices related to one or more health care conditions.

As used herein, the term “sponsor” or “benefits sponsor” is used to refer to any person, website, physical location, retailer, manufacturer, distributor, insurer, employer, financial institution, issuer, acquirer, consumer, hardware, software, or any other entity that desires to provide benefits to the system in accordance with the present invention.

Persons skilled in the art will understand the breadth of the terms used herein and that the exemplary descriptions provided are not intended to limit the generally understood meanings of the foregoing terms.

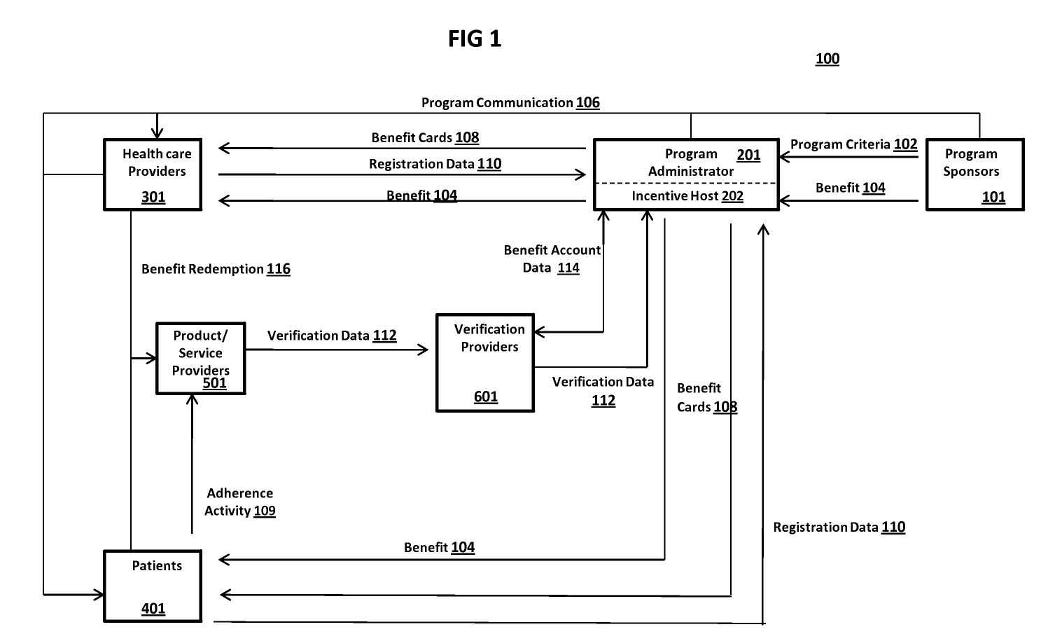

In reference to the drawings, FIG. 1 is a block diagram that schematically describes an overview of an adherence incentive system 100 for providing benefits to health care providers for the completion or fulfillment by patients of adherence activities in accordance with one embodiment of the present invention. In an embodiment, system 100 includes a computer implemented incentive host system 202 operated by a program administrator 201 that connects adherence incentive system 100 participants, including program sponsors 101, health care providers 301, patients 401, verification services 601 and merchants 501. Host 202 contains a plurality of modules and databases and may communicate with program participants using a variety of communication mechanisms as will be discussed in more detail below. Those skilled in the art will appreciate that a large number of sponsors 101, health care providers 301, patients 401, verification services 601 and merchants 801 may be in communication with host 202. It should also be understood that any number of individuals, health care providers, merchants, manufacturers, businesses, sponsors, system providers and the like may participate in the systems and methods of the present invention.

And though the methods and systems described herein are generically described with reference to block and functional diagrams, these diagrams are provided purely for illustration of some of the embodiments of the present invention and should not be construed to limit the scope or types of hardware, software or other means of providing the system. Moreover, those of ordinary skill in the art will appreciate that the present invention may be embodied as a single or multiple methods, as an entirely software embodiment, an entirely hardware embodiment, or an embodiment combining aspects of both software and hardware.

In reference to FIG. 1, adherence incentive programs 102 are established by program sponsors 101, and, in some embodiments, include rules or other criteria that patients and/or providers must comply with in order to receive benefits in accordance with the present invention. In an embodiment, program criteria may include, for example, eligibility qualifications of providers or patients, program registration requirements, adherence activities eligible for benefits, adherence activity verification requirements, and eligible benefit redemption restrictions and methods. Program sponsors 101 transmit adherence programs 102 over a network to host 202. In an embodiment, program sponsors 101 or program administrator 201, either individually or cooperatively, may communicate the details 106 of incentive programs 102 to health care providers 301 and/or patients 401 for purposes of encouraging their participation in program 102. Such communications may take the form of, for example, advertising, either via print or electronic media, direct sales, direct marketing, email, telesales, or physical mail. Those familiar with the art will recognize the multiple forms of marketing and advertising available for communicating incentive or rewards programs to health care providers and patients.

In an embodiment, eligible providers 301 may be required to register to participate in programs 102 by communicating with incentive system host 202 and providing items of data sufficient to identify the provider 301, the participating program 102, the patients 401 for whose adherence activities the provider may receive a benefit and the provider's benefit account number. In one embodiment, system host 202 may generate a provider benefit account number upon the provider's initial registration. In one embodiment, the provider's benefit account number may be communicated to the provider using print or electronic media, such as, for example, email, physical mail, a voice response unit (“VRU”), or the like. In one embodiment, the provider's 301 benefit account number may represent participation in a plurality of adherence programs 108.

In one embodiment wherein patient adherence benefits are offered to both a provider and a patient, eligible providers and patients may be required to register by communicating with incentive system host 202 and providing items of data sufficient to identify the provider 301, the participating program 102, the patients 401 for whose adherence activities the provider may receive a benefit, the provider's benefit account number and the patient's benefit account number. In one embodiment, prior to registration, patients 401 are provided with one or more benefit cards 108 associated with a benefits account indicating eligibility to participate in an adherence program 102. Benefit cards 108 may bear indicia, such as an alphanumeric identifier, representing a unique identifier of a benefit account associated with a particular adherence program 102 and allows the patient to register for the program associated with the benefit card. Cards 108 may initially be non-activated such that they will not be recognized by incentive host 202 as being associated with an eligible benefits account. In an embodiment, activation of cards 108 occurs only upon registration of the card 108 account number with incentive system host 202. In an embodiment, benefit cards 108 may be comprised of features that allow the card to operate as a payment card for purposes of redemption. In some embodiments, benefit cards 108 may take the form of a token, card or other device that is associated with a benefit account pursuant to the present invention. Pursuant to some embodiments, benefit cards 108 may be provided in any of a number of different forms, including as a standard ISO 7816 magnetic stripe card (such as a debit card, credit card, stored value card, prescription card, medical card, or the like) as an RFID chip encapsulated in a card or other device, as a chip or application embodied in a smart phone or PDA, or as a virtual account number so long as the benefit card identifies (or allows identification of) an associated benefit account. In some embodiments, benefit cards 108 may be operable on an open loop payment card network such as the BankNet® network operated by MasterCard International Incorporated, or the VisaNet® network operated by Visa International Service Association, or the networks branded as NYCE, STAR, or the like. In some embodiments, benefit cards 108 may be issued to operate in a closed loop payment card network such as those operated by American Express or Discover, or in a closed loop, private label network. In some embodiment, cards 108 are distributed to eligible providers, who, in turn distribute cards to eligible patients. In some embodiments, cards 108 are issued to both eligible providers 301 and eligible patients 401 and are used for accessing their respective program benefit accounts.

In one embodiment, providers 301 and patients 401 may be automatically registered in an adherence program by, for example, a program sponsor. For example, an employer sponsor 101 may offer an adherence program 108 to provide benefits to providers and employees for each fulfillment by the employee of their prescribed diabetes medication. In this example, the employer may automatically register in an adherence program 108 employees that are being treated for diabetes and providers that specialize in diabetes care and are members of the employer's preferred provider network.

In an embodiment, registered providers 301 and patients 401 in an adherence program 108 may earn benefits when the registered patient performs the adherence activities 109 of the program. In one embodiment, benefits are awarded only upon confirmation of the patient's and provider's compliance with program 102 criteria, including verification of the performance of adherence activities 109 by either the program administrator 201 or by a verification service provider 601, such as, for example, a health insurance provider, a health care insurance claims adjudicator, a health care claims clearinghouse, a prescription benefits manager, a pharmacy, a third party administrator, a merchant, or a health care provider. In one embodiment, verification of the patient's performance of an adherence activity 109 at a merchant or service provider 501 occurs when merchant or service provider 501 transmits verification information 112 either directly to host 202 or using the services of a verification service provider 601. For example, a patient may be registered in an adherence program that awards a benefit to the patient and a registered provider for each fulfillment of a diabetes prescription by the patient and the approval of an adjudicated prescription benefit claim corresponding to the prescription purchase. The patient fills the prescription at a pharmacy that in turn submits an insurance claim to a pharmacy benefits manager that adjudicates insurance claims associated with the patient's prescription benefit plan. The pharmacy benefits manager in turn transmits the adjudicated claim to the program administrator as verification of the performance of the adherence activity.

Host 202 receives verification information 112 and determines if program eligibility criteria 102, including performance of adherence activity, have been met. Once compliance with eligibility criteria 102 has been confirmed, host 202 awards benefits to benefit card 108 accounts, which are then eligible for redemption 116 at merchants or other service providers 501.

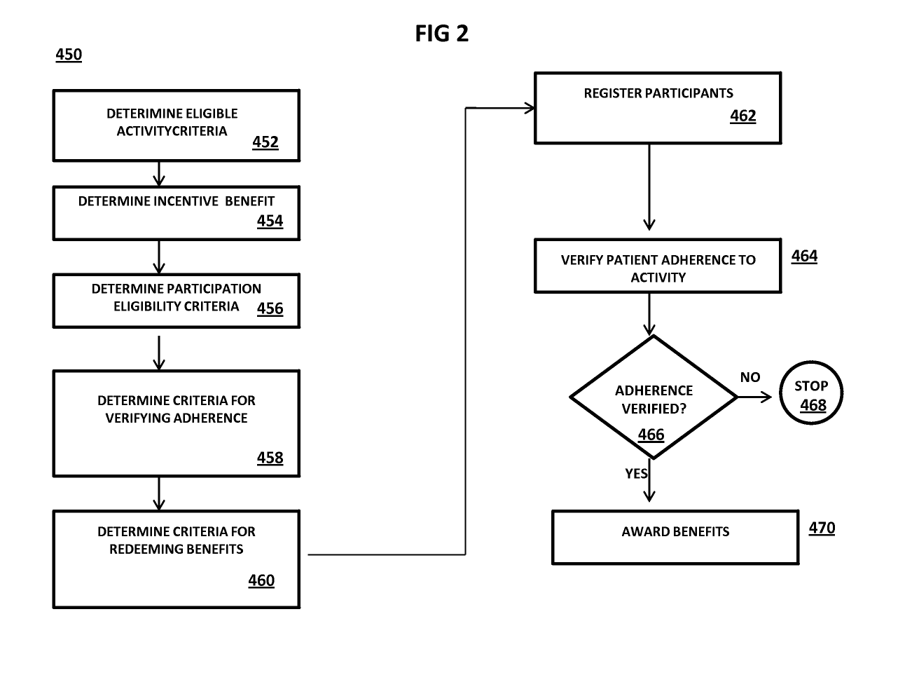

FIG. 2 is a flow diagram depicting a general method 450 of providing incentive benefits to health care providers for adherence of their patients to specified health-related activities in accordance with the present invention. Incentive processing begins at step 452 with a program sponsor identifying an eligible patient activity, such as, for example, the filling of a prescription, adherence to which a benefit will be awarded. Those skilled in the art will appreciate that health care providers recommend or prescribe a wide variety of therapeutic or preventative treatments and that patients often neglect to adhere to these prescribed or recommended treatments. The prospect of receiving a benefit for a patient's adherence to an eligible activity incents providers to take active steps in encouraging the fulfillment of these activities by their patients. Program sponsors are willing to offer these incentives to providers because greater patient adherence to the eligible activity provides benefits to the sponsors in the form of, for example, increased product sales, fewer insurance claims resulting from healthier patients, or the like. In an embodiment, sponsors may specify an activity that requires a patient to purchase a particular product or products, uniquely identified as such by a UPC code, an NDC code, an ISBN code, a bar code, or the like). In an embodiment, sponsors may specify an adherence activity that requires the patient to receive a particular health care procedure, uniquely identified as such by a CPT code, a CPT4 code or the like).

Method 450 continues at step 454 where a determination is made of a benefit or benefits to be awarded once verification has been made of the patient's compliance with a program's incented activity. In some embodiments, a sponsor may offer benefits only to a provider. In some embodiments, a sponsor may offer benefits to both a provider and a patient.

At step 456, eligibility criteria for participation in the adherence incentive program are determined. In some embodiments, participation is defined to include patients or health care providers located within a certain geographical region, such as, for example, a state, a city or other geographical subdivision. In some embodiments, participation is limited to health care providers of a certain specialty, such as, for example, pediatric care, cardiology, general practice, dentistry, vision care, psychiatry, orthopedics, dentistry, physical therapy, endocrinology, or the like. Those skilled in the art will appreciate that there are numerous areas and specialties of health care practice that a sponsor may desire to incent under the present invention and that sponsors may wish to limit participation to providers with patients who require the therapies being promoted by the sponsor. In some embodiments, the eligible provider may be a pharmacist. For example, a pharmaceutical manufacturer may wish to provide an incentive for a pharmacist to spend more time explaining the benefits of a particular drug therapy or prescription to patients. Patients who better understand a particular drug may be more inclined to adhere to taking the prescription drug and the pharmacist would be provided a benefit by the pharmaceutical company for the patient's adherence. In some embodiments, participation criteria may specify patients with a specified health care condition, such as, for example, diabetes. In some embodiments, participation may be limited to patients who require periodic treatments of specialty pharmaceutical products, such as infusions, intravenous medications, and the like.

At 458, a determination is made as to how to verify patient compliance with the eligible activity defined at step 452. In various embodiments, verification criteria may include evidence of an adjudicated insurance claim from an insurance plan or a PBM, product purchase data from merchants, sales receipts from a patient, or confirmation of an activity from a health care provider.

At 460, a determination is made as to how benefits are to be redeemed by program beneficiaries. In one embodiment, redemptions are unrestricted. In one embodiment, benefits are restricted to purchases of specified products or products purchased at specified merchants. In one embodiment, patient redemptions are restricted to amounts a patient owes for insurance copayments or insurance deductibles associated with insurance claims for eligible activities under the incentive program.

At 462, eligible participants register for the adherence incentive program. In an embodiment, registration includes communicating with the program sponsor or a program administrator responsible for administering the incentive program. In an embodiment this communication includes providing a unique provider identification, one or more unique patient identifications, and a program identifier that identifies the incentive program. In an embodiment, upon registration eligible participants are issued a program token, such as, for example, a benefit card, that identifies their participation in the program.

At 464, verification of patient adherence is performed. In an embodiment, verification includes confirmation of receipt of an adjudicated insurance claim. In an embodiment, verification includes confirmation of a product purchase using point of sale data from a merchant. In an embodiment, verification includes confirmation of performance of a procedure by a health care provider.

If, at 466, verification of patient adherence is confirmed, at 468 benefits are awarded to the eligible participants.

If, at 466, verification of patient adherence is not confirmed, processing ceases at 470 and no benefits are awarded.

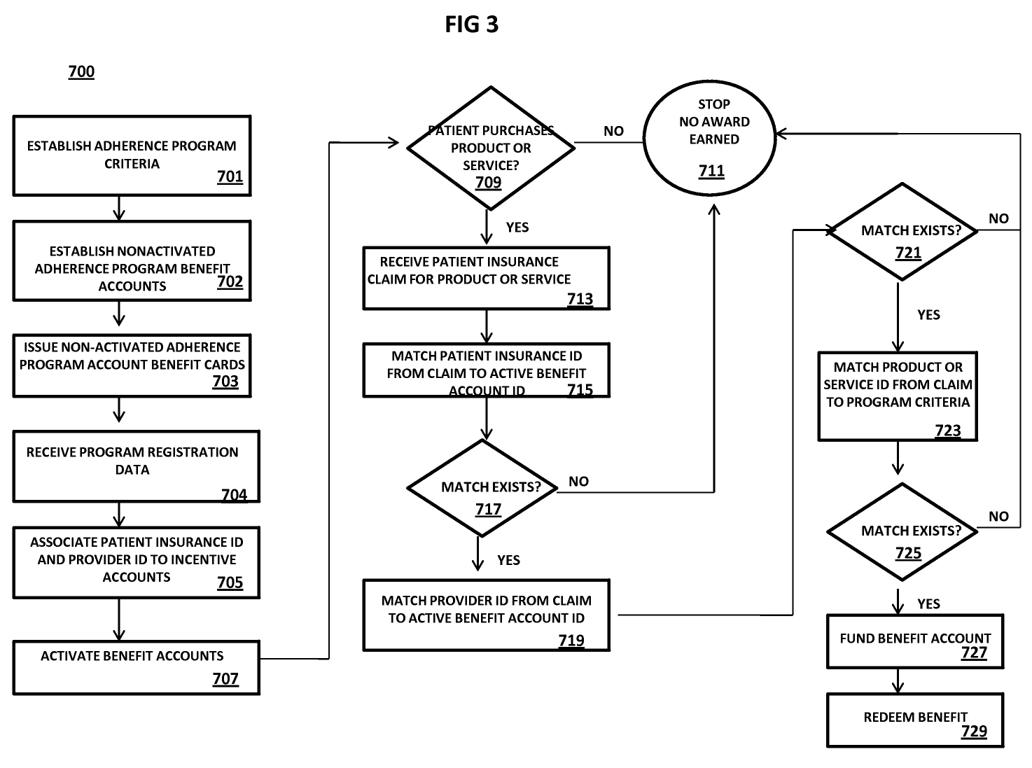

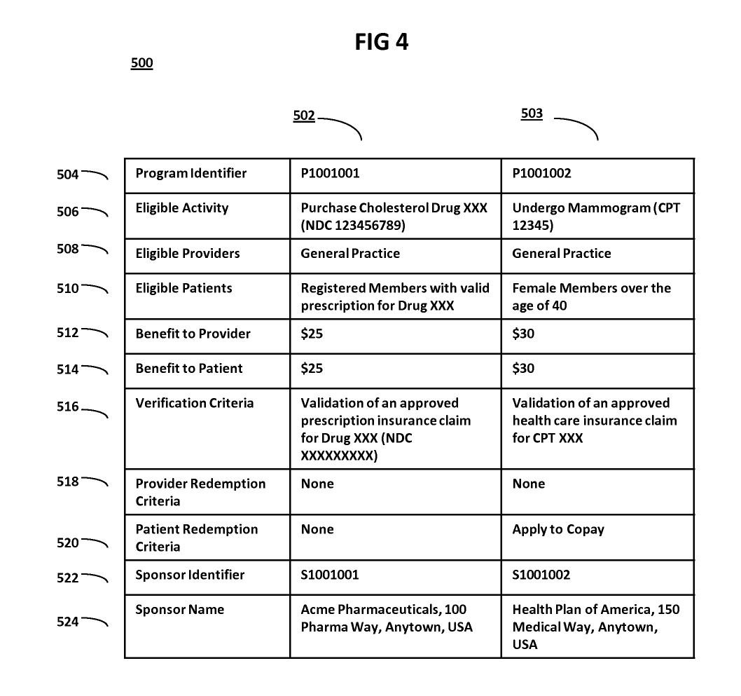

FIG. 3 is a flow diagram depicting a method 700 of providing incentive benefits to health care providers for patient adherence to a prescribed pharmaceutical or health care therapy. Beginning at step 701, a sponsor establishes an adherence program, such as example programs 502 and 503 shown in program database 500 of FIG. 4. In example 502, a pharmaceutical company offers incentives to eligible providers and patients for the patient's adherence to filling a prescription. Example 503 illustrates an adherence program offered by a health insurer whereby the insurer provides benefits to eligible providers and patients for undergoing a mammography exam by an eligible patient. In some embodiments, programs are defined using a number of parameters, such as, for example in FIG. 4, a program identifier 504, an identification of eligible activities 506, an identification of eligibility criteria for providers 508 and patients 510, the provider benefit 512, the patient benefit 514, criteria used to verify program adherence 516, provider 518 and patient 520 redemption restrictions, a program sponsor identifier 522 and the sponsor name and address 524. Sponsors may establish a plurality of programs and a single program may have a plurality of sponsors.

Continuing with method 700 (FIG. 3), at step 702 non-activated benefit accounts associated with a program are established in order to allow distribution of benefit cards to providers and patients eligible to register for the adherence program.

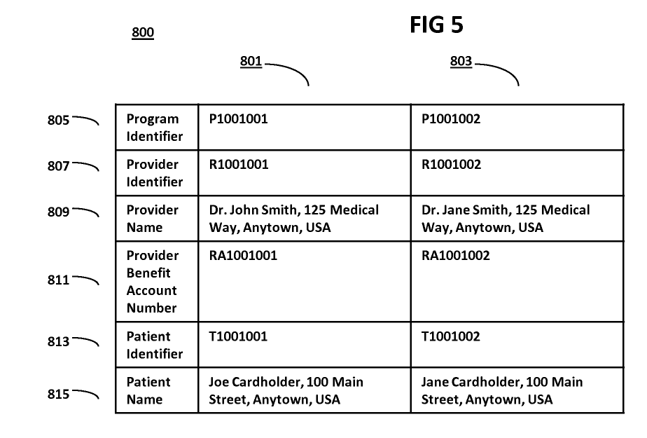

At step 703, benefit cards associated with the non-activated benefit accounts are then distributed to providers and patients eligible to register for the program. At step 704, eligible providers and patients register for an adherence program by communicating with, for example, a program administrator 201 (FIG. 1) and providing registration information. FIG. 5 shows an exemplary program registration database 800, which includes examples 801 and 803 of registration data that may be provided under some embodiments by eligible providers for exemplary programs 501 and 503 (FIG. 3) established at step 701. Field 803 identifies the program. Field 805 is an identifier that uniquely identifies the provider. Field 807 is the provider name. Field 809 is the provider benefit account number. In one embodiment, the provider benefit account number is obtained from a non-activated benefit card received by the provider from the program administrator 201 (FIG. 1). Field 811 includes a unique patient identifier. In one embodiment, the patient identifier is the patient's member identification associated with the patient's health insurance plan. In one embodiment, the patient identifier is the patient's member identification associated with the patient's prescription insurance plan. Field 813 includes the patient's name and address. Field 815 includes the patient's benefit account number. In one embodiment, the patient's benefit account number is the account identifier associated with the benefit card received by patient at step 703. It should be understood that a single provider benefit account may be associated with multiple adherence programs.

At step 705, the benefit account of the patient registered at step 704 is associated with the patient's insurance plan to allow for verification of a program activity using a submitted insurance claim.

At step 707, the benefit accounts of the patient and the provider are activated such that benefits may accrue to these accounts based upon patient adherence to the adherence program criteria established at step 701.

If patients, at 709, perform the adherence activity in accordance with program criteria, processing continues at step 711. For example, in program 502, if a program registered patient purchases or fills the prescription drug NDC XXXXXXX, as specified by the program sponsor at step 701, at 713, the pharmacy would submit an insurance benefit claim to the pharmacy benefits manager or insurance company responsible for adjudicating prescription claims under the patient's prescription benefit plan. Likewise, in program 503, a program registered patient that undergoes a mammography in accordance with criteria established at step 701, the provider responsible for the test would submit an insurance benefit claim the patient's health insurance claim indicating the administering of CPT code XXXXXXXXXX. If, at 709, the patient fails to comply with the program requirements established at step 701, by, for example, not performing the adherence activity specified by the program criteria, processing stops and no benefit is awarded to either the patient or the provider.

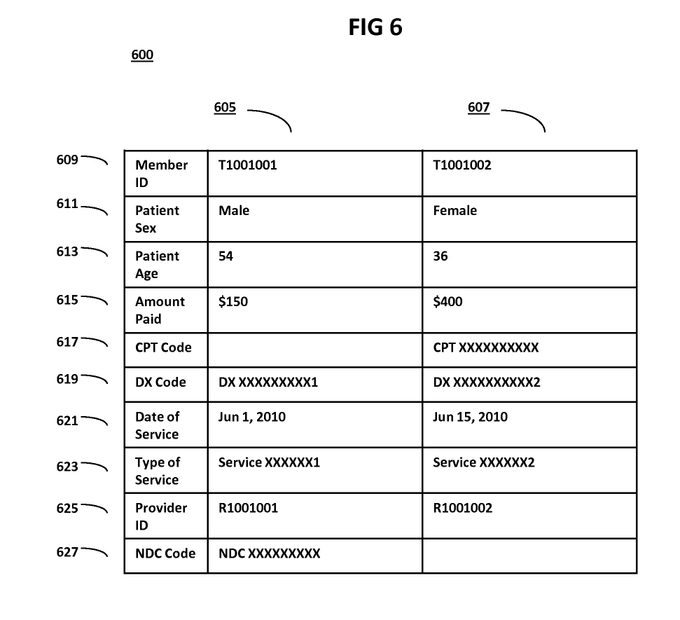

At step 713, an insurance claim is received for the activity performed at step 709. FIG. 6 is a portion of a tabular representation of exemplary insurance claims 605 and 607 in accordance with some embodiments of the present invention. Claims 605 and 607 include several data fields, including, for example, member identifier 609, which is a unique identifier for each patient in a health plan; patient sex 611, patient age 613, amount paid 615, indicating the adjudicated amount or the amount the payor pays to the provider excluding co-pays and deductibles; CPT code 617, an industry standard code which designates the type of procedure or action provided; DX code 619, an industry standard (ICD-9) code which designates an additional diagnosis, if any (there could be multiple DX codes with each claim); date of service 621, the date the service was provided; type of service 623, a code which indicates the type of charge, if the CPT4 code is not available; provider identifier 625, unique identifier for the provider; and NDC code 627, an industry standard code which identifies a drug.

At 715, the member identifier 609 is compared to member identifiers 811 from registration step 704 to determine if the claimant is registered in an adherence program. If, at 717, no match is found processing stops at 711 and no benefit is awarded.

If, at 717, a match is found, processing continues at 719 where provider identifier 625 is compared to provider identifiers 805 from step 704. If, at 721, no match is found processing stops at 711 and no benefit is awarded.

If, at 721, a match is found, processing continues at step 723 where CPT code 617 or NDC code 627 match activity eligibility code 506 from step 701. If, at 725, no match is found processing stops at 711 and no benefit is awarded.

If, at 725, a match is found, processing continues at step 727 where benefits 512 and 514 are transferred to the benefit accounts 809 and 815 of the providers and patients, respectively.

At step 729, providers and patients redeem benefits.

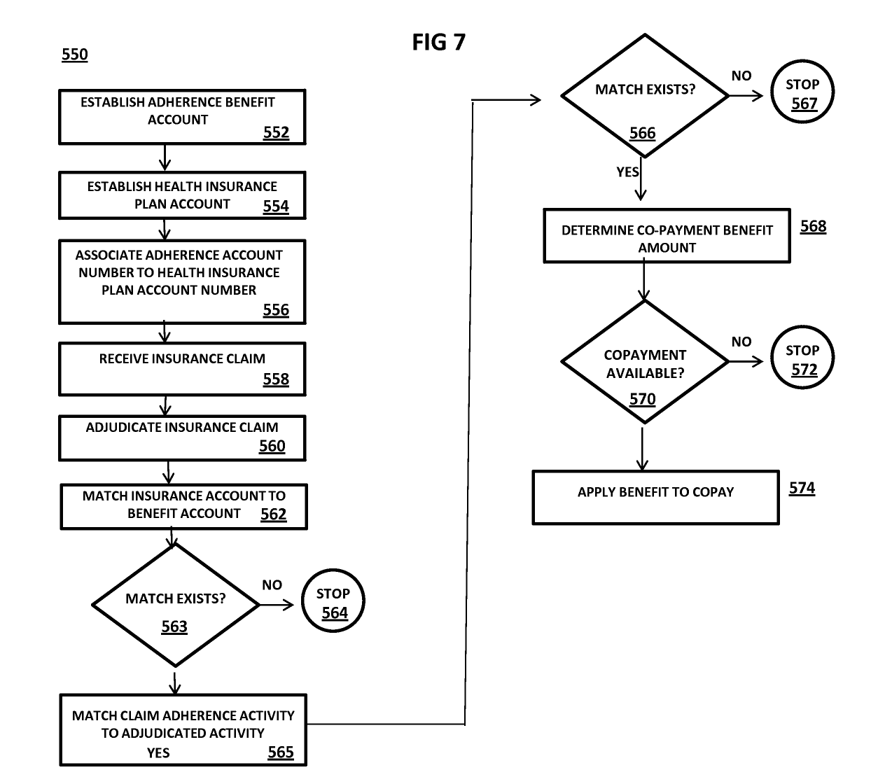

FIG. 7 shows a method 550 of associating an adherence benefit account with a health insurance plan account for purposes of applying an adherence benefit to an insurance copay amount. Processing begins at 552 with the establishment of an adherence benefit account by an eligible patient and an eligible provider in accordance with a adherence incentive system, such as system 100 (FIG. 1). At 554 a health insurance plan configured to require insurance co-pays is established by the eligible patient. In some embodiments, the patient may already be enrolled in a health insurance plan. At 556 the adherence benefit account number from step 552 is associated with the health insurance account number from step 554. In some embodiments, such association is maintained in a database operated by, for example, a program administrator. At 558 a health insurance claim is received requesting payment for some or all of the amount due for a treatment activity of the patient under the terms of the health insurance plan established at 554. At 560, the insurance claim is adjudicated to determine an amount approved for payment by the insurance payor under the insurance plan and an amount due in the form of a co-payment by the patient. At 562, the insurance plan account of step 560 is matched to an adherence benefit account using the associations established at step 556. If, at 563, no match is found processing stops. If, at 563, processing continues at 565 where the adherence activity of the claim adjudicated at 562 is matched to an eligible adherence activity associated with the benefit account matched to the insurance plan matched at 562. If, at 566, no match exists, processing stops. If, at 566, a match exists, at 568 an adherence benefit co-payment benefit is determined based upon the benefits associated with the adherence account established at 552. If, at 570, a co-payment benefit is available, the co-payment is applied at 574 up to the co-payment amount computed at step 560. If, at 570, a copayment benefit is not available, processing stops at 572.

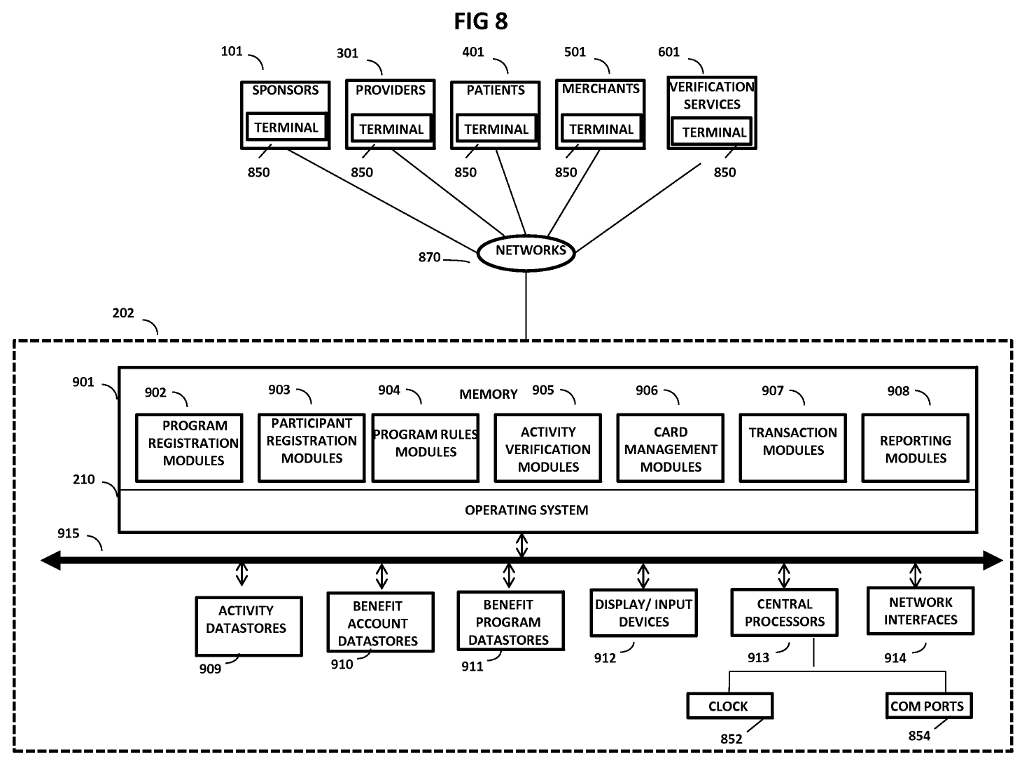

FIG. 8 is a block diagram a more detailed depiction of one embodiment of incentive host system 202 that can be used for implementing an adherence system in accordance with the present invention. System 202 may be any hardware and/or software suitably configured to communicate and/or process information in order to implement the purposes of the present invention. System 202 connects program participants, including, in an embodiment, sponsors 101, health care providers 301, patients 401, merchants 501, and verification service providers 601 with program administrator 201 (FIG. 1) over a network or networks 851 using terminals 850 and a host system network interface 914. Computer terminals 850 and network interface 914 may be any type of computing device, such as a personal computer, a workstation, a network terminal, a hand-held device, a point of sale terminal, a kiosk, a personal digital assistant, a cell phone or any other device or combination of devices that can accomplish two-way electronic communication over the networks 851. Terminals 850 and network interface 914 may each additionally communicate with other remote computers (not shown) or other devices (not shown) in order to achieve the various purposes of the present invention. Networks 851 may include the internet, LANs, WANs, MANs, wireless networks, intranets, extranets or any other type of computer network, such as those enabled over public switched telephone networks.

FIG. 8 shows a number of exemplary components of an incentive host system 201 in accordance with some embodiments of the present invention. The system may include one or more central processors 913, which may be one or more of any commonly available microprocessors, such as, for example, the PENTIUM or CORE class of processors manufactured by INTEL CORP. If the processor 913 comprises a plurality of microprocessors, the plurality of microprocessors may or may not operate in parallel. The processor 913 may be operatively in communication with further exemplary components such as a clock 852, a communications (“COM”) port 854, memory 901, network interfaces 914, devices for displaying, outputting or inputting data 912, and various datastores 911, 910 and 909. Central processor 913 may communicate with other elements of host system 202 through a system interface or bus 915.

Processor 913 may operate in conjunction with random access memory (RAM) and read-only memory (ROM) in a manner familiar to those of ordinary skill in the art. The RAM (not shown) portion of the RAM/ROM memory may be a suitable number of Single In-line Memory Module chips having a storage capacity sufficient to store and transfer processing instructions used by the processor 913 which may be received from other computer programs or modules of system 201. The ROM memory (not shown) portion of the RAM/ROM memory may be any permanent, non-rewritable memory medium capable of storing and transferring processing instructions performed by the processor 913 during, for example, the startup routine of host system 201.

The clock 852 may be an on-board component of the processor 913 which dictates a clock speed at which the processor 913 performs and synchronizes communication between the internal components of processor 913 and/or other components of system 201. Suitable display/input/output devices 912 such as, for example, keyboards, monitors and printers, may be provided for receiving or outputting data from and inputting data to host system 201 or to transmit data over networks 851 to terminals 850. Communication port 854 may include a telephonic or network connection device, such as a telephone modem, a cable modem, a T-1, T-2 or T-3 connection, a digital subscriber line or a network card, for communicating data to and from other computer devices of the networks 851 or bus 915.

Computer memory 901 associated with host system 201 may be an internal or external large capacity device for storing computer processing instructions, computer-readable data, and the like. Computer memory 901 may include an operating system 210, such as, for example, a version of the WINDOWS system by MICROSOFT CORP., a version of the UNIX or LINUX operating systems, or a version of operating systems produced by APPLE, INC., which enables execution by processor 913 of the various software modules described herein. Computer memory 901 may also include other applications (not shown), such as a web or internet hosting program for allowing participants to submit information to system 202, a database management system, of the type, for example, manufactured by ORACLE, for managing datastores 909, 910 and 911, and various device drivers for allowing processor 913 to communicate with other computer devices of system 202.

Memory 901 may also include a plurality of software modules to facilitate the execution of system 201, such as, for example, sponsor and program registration modules 902 for enrolling sponsors 101 and/or sponsor incentive programs, such as, for example, programs 502 and 503 (FIG. 4); program rules modules 904 for determining benefit amounts using patient activity and registration data and program criteria data; activity verification modules 905 for receiving activity data and verifying the performance of activities using program criteria data; card management models 906 for facilitating the issuance, activation, and deactivation of benefit card accounts, and managing benefit card account balances, such as, for example, updating account balances with benefits; transaction modules 907 for facilitating the processing of benefit redemption transactions; and reporting modules 908 for generating information and data for reporting to incentive program participants, including, for example, the program administrator 201 (FIG. 1), providers 301, benefit sponsors 101, merchants 501, patients 401, and verification service providers 601.

System 202 may also include a number of relational databases, which store data that may be used for implementing incentive programs in accordance with the present invention. A benefit program database 909 may, for example, include program data representing incentive programs offered by sponsors and arranged in a tabular structure such as program table 500 (FIG. 4). A benefit account database 910 may, for example, include data representing eligible or registered patients and providers and arranged in a tabular structure such as table 800 (FIG. 5). An activity database 911, may, for example, include data representing verified or unverified patient activity, including purchases data, insurance claims, data input by health care providers, and the like, and arranged in a tabular structure such as table 600 (FIG. 6). The datastores discussed herein, such as for example, 909, 910 and 911 may be any type of database, such as relational, hierarchical, object-oriented, or the like. The first row of each datastore may include a field header for each field of the database and the remaining rows each correspond to one record of the database. Fields of data are represented by each column. More or fewer fields and records of data may be used. Datastores may employ the use of data tables that can be merged using, for example, key fields, and may be re-configured into any number of relational databases. In addition, configurations other than standard database formats may be used to store the data maintained in exemplary databases 909-911.

System 202 may also be configured with access rights to participants 102, 301, 401, 501 and 601 to allow or deny the ability to update, view or modify features of system 202, such as, for example, enrollment data, benefit account or activity data.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some embodiments, a method for providing a benefit to a health care provider may include identifying at least one health care provider, wherein the identification comprises at least one of: an identifier associated with the provider and the name of the provider; identifying at least one patient, wherein the identification comprises at least one of: an identifier associated with the patient and the name of the patient; designating at least one adherence activity that said patient is to perform wherein said adherence activity is consistent with a preventative or therapeutic treatment prescribed by said health care provider; designating a provider benefit amount for said provider wherein said provider benefit amount is associated with the performance of said adherence activity by said patient; establishing a provider benefit account that is associated with said provider wherein said provider benefit account is associated with a provider benefit account identifier; verifying the performance of said adherence activity by said patient; calculating a provider benefit amount for said provider based, at least in part, on the performance of said adherence activity by said patient; and crediting said calculated provider benefit amount to said provider benefit account.

The health care provider may be at least one of: a licensed physician, a licensed dentist, a licensed psychiatrist, a licensed pharmacist, a licensed chiropractic, or a licensed nurse. The adherence activity may be, for example, one or more of: the purchase of a prescription, the filling of a prescription, the purchase of an over-the-counter drug, the receiving of an intravenous medicine; the receiving of a transfusion; the receiving of a radiation treatment; the receiving of a physical examination, the receiving of a blood test, the receiving of a cancer screening, the receiving of a teeth-cleaning, the receiving of a mammogram, the receiving of a pap smear, the receiving of a sigmoidoscopy, the receiving of a colonoscopy, the receiving of an immunization, the receiving of a psychiatry examination, the receiving of a psychological examination, the receiving of a dental examination, the cessation of smoking, the cessation of alcohol consumption, the cessation of consumption of controlled substances, the participation in a clinical trial or a preventative health treatment.

The benefit amount may be provided by at least one benefit sponsor, and the sponsor may be at least one of: a pharmaceutical manufacturer, a pharmacy benefits manager, an employer, a hospital, and health insurance company, a retailer, a state, federal or local government agency, or a charitable institution. The identifier of the provider may be: a National Provider Identifier, and/or a provider benefit account identifier. The identifier of the patient may be a subscriber or member number associated with a health insurance plan, or a patient benefit account identifier. A benefit card associated with the provider benefit account may be issued or provided by or to the provider, and may be one of an open or closed loop card, a debit card, a credit card or a stored value card. The benefit card may be issued by one of a financial institution, a program administrator, a pharmaceutical manufacturer, a pharmacy benefits manager, an employer, a hospital, and health insurance company, a retailer, a state, federal or local government agency, or a charitable institution.

Verifying the performance of an adherence activity by a patient may include receiving an insurance claim associated with said patient from an insurance provider associated with the patient and calculating, based at least in part on the insurance claim, a provider benefit amount. The insurance claim may be associated with a health insurance plan issued to the patient. The health insurance plan may be one of a health care plan or a prescription benefits plan.

Verifying the performance of an adherence activity by a patient may further include receiving a patient identifier and product data associated with a purchase by the patient of at least one product and calculating, based at least in part on the patient identifier and the product data, a provider benefit amount. The product data may include at least one of a stock keeping unit (SKU), a National Drug Code (“NDC”), a Universal Product Code (“UPC”), an ISBN, or a Current Procedural Terminology (“CPT”) code.

Verifying the performance of an adherence activity by a patient may further include associating the patient account identifier to an insurance health plan account identifier associated with the patient; receiving an insurance claim associated with said insurance health plan, wherein said insurance claim includes at least a health plan account identifier, a treatment identifier or a prescription identifier; determining if said insurance plan account identifier corresponds to an patient benefit account identifier; and, determining if said treatment identifier or prescription identifier corresponds to an adherence activity.

In some embodiments, a method for providing a benefit to a health care provider and a patient includes identifying at least one health care provider, wherein the identification comprises at least one of: an identifier associated with the provider and the name of the provider, Identifying at least one patient, wherein the identification comprises at least one of: an identifier associated with the patient and the name of the patient, designating at least one adherence activity that said patient is to perform wherein said adherence activity is consistent with a preventative or therapeutic treatment prescribed by said health care provider, designating a provider benefit amount for said provider wherein said provider benefit amount is associated with the performance of said adherence activity by said patient, designating a patient benefit amount for said patient wherein said patient benefit amount is associated with the performance of said adherence activity by said patient; establishing a provider benefit account that is associated with said provider wherein said provider benefit account is associated with a provider benefit account identifier; establishing a patient benefit account that is associated with said patient wherein said patient benefit account is associated with a patient benefit account identifier; verifying the performance of said adherence activity by said patient; calculating a provider benefit amount for said provider based, at least in part, on the performance of said adherence activity by said patient; calculating a patient benefit amount for said patient based, at least in part, on the performance of said adherence activity by said patient; crediting said calculated provider benefit amount to said provider benefit account; and crediting said calculated patient benefit amount to said patient benefit account.

The health care provider may be one or more of: a licensed physician, a licensed dentist, a licensed psychiatrist, a licensed pharmacist, a licensed chiropractic, or a licensed nurse.

In some embodiments, the adherence activity comprises at least one of: the purchase of a prescription, the filling of a prescription, the purchase of an over-the-counter drug, the receiving of an intravenous medicine; the receiving of a transfusion; the receiving of a radiation treatment; the receiving of a physical examination, the receiving of a blood test, the receiving of a cancer screening, the receiving of a teeth-cleaning, the receiving of a mammogram, the receiving of a pap smear, the receiving of a sigmoidoscopy, the receiving of a colonoscopy, the receiving of an immunization, the receiving of a psychiatry examination, the receiving of a psychological examination, the receiving of a dental examination, the cessation of smoking, the cessation of alcohol consumption, the cessation of consumption of controlled substances, the participation in a clinical trial or a preventative health treatment.

In some embodiments, the benefit amount is provided by at least one benefit sponsor, where the benefit sponsor is one or more of a pharmaceutical manufacturer, a pharmacy benefits manager, an employer, a hospital, and health insurance company, a retailer, a state, federal or local government agency, or a charitable institution.

Moreover, although specific hardware and data configurations have been described herein, note that any number of other configurations may be provided in accordance with embodiments of the present invention. The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for providing a benefit to a health care provider comprising:
identifying at least one health care provider, wherein the identification comprises at least one of: an identifier associated with the provider and the name of the provider;
identifying at least one patient, wherein the identification comprises at least one of: an identifier associated with the patient and the name of the patient;
designating at least one adherence activity that said patient is to perform wherein said adherence activity is consistent with a preventative or therapeutic treatment prescribed by said health care provider;
designating a provider benefit amount for said provider wherein said provider benefit amount is associated with the performance of said adherence activity by said patient;
establishing a provider benefit account that is associated with said provider wherein said provider benefit account is associated with a provider benefit account identifier;
verifying the performance of said adherence activity by said patient;
calculating a provider benefit amount for said provider based, at least in part, on the performance of said adherence activity by said patient; and
crediting said calculated provider benefit amount to said provider benefit account.

2. The method of claim 1 wherein the health care provider comprises at least one of: a licensed physician, a licensed dentist, a licensed psychiatrist, a licensed pharmacist, a licensed chiropractic, or a licensed nurse.

3. The method of claim 1 wherein the adherence activity comprises at least one of: the purchase of a prescription, the filling of a prescription, the purchase of an over-the-counter drug, the receiving of an intravenous medicine; the receiving of a transfusion; the receiving of a radiation treatment; the receiving of a physical examination, the receiving of a blood test, the receiving of a cancer screening, the receiving of a teeth-cleaning, the receiving of a mammogram, the receiving of a pap smear, the receiving of a sigmoidoscopy, the receiving of a colonoscopy, the receiving of an immunization, the receiving of a psychiatry examination, the receiving of a psychological examination, the receiving of a dental examination, the cessation of smoking, the cessation of alcohol consumption, the cessation of consumption of controlled substances, the participation in a clinical trial or a preventative health treatment.

4. The method of claim 1 wherein said benefit amount is provided by at least one benefit sponsor, wherein said sponsor comprises at least one of: a pharmaceutical manufacturer, a pharmacy benefits manager, an employer, a hospital, and health insurance company, a retailer, a state, federal or local government agency, or a charitable institution.

5. The method of claim 1 wherein said identifier of said provider comprises at least one of a National Provider Identifier, and a provider benefit account identifier.

6. The method of claim 1 wherein said identifier of said patient comprises at least one of a subscriber or member number associated with a health insurance plan and a patient benefit account identifier.

7. The method of claim 1 wherein the benefit account is provided by a program administrator.

8. The method of claim 1 further comprising providing a benefit card associated with said provider benefit account to said provider, said benefit card comprising at least one of a debit card, a credit card or a stored value card.

9. The method of claim 8 wherein said benefit card is an open loop or closed loop card.

10. The method of claim 8 wherein the benefit card is issued by one of a financial institution, a program administrator, a pharmaceutical manufacturer, a pharmacy benefits manager, an employer, a hospital, and health insurance company, a retailer, a state, federal or local government agency, or a charitable institution.

11. The method of claim 10 further comprising displaying the logo of said issuer on said benefit card.

12. The method of claim 1 wherein verifying the performance of an adherence activity by a patient further comprises receiving an insurance claim associated with said patient from an insurance provider associated with said patient and calculating, based at least in part on said insurance claim, a provider benefit amount.

13. The method of claim 12 wherein said insurance claim is associated with a health insurance plan issued to said patient.

14. The method of claim 13 wherein said health insurance plan is one of a health care plan or a prescription benefits plan.

15. The method of claim 1 wherein verifying the performance of an adherence activity by a patient further comprises receiving a patient identifier and product data associated with a purchase by said patient of at least one product and calculating, based at least in part on said patient identifier and said product data, a provider benefit amount.

16. The method of claim 15 wherein said product data comprises at least one of a stock keeping unit (SKU), a National Drug Code (“NDC”), a Universal Product Code (“UPC”), an ISBN, or a Current Procedural Terminology (“CPT”) code.

17. The method of claim 1 wherein verifying the performance of an adherence activity by a patient further comprises:
associating said patient account identifier to an insurance health plan account identifier associated with said patient;
receiving an insurance claim associated with said insurance health plan, wherein said insurance claim includes at least a health plan account identifier, a treatment identifier or a prescription identifier;
determining if said insurance plan account identifier corresponds to an patient benefit account identifier; and,
determining if said treatment identifier or prescription identifier corresponds to an adherence activity.

18. A method for providing a benefit to a health care provider and a patient comprising:
Identifying at least one health care provider, wherein the identification comprises at least one of: an identifier associated with the provider and the name of the provider;
Identifying at least one patient, wherein the identification comprises at least one of: an identifier associated with the patient and the name of the patient;
designating at least one adherence activity that said patient is to perform wherein said adherence activity is consistent with a preventative or therapeutic treatment prescribed by said health care provider;
designating a provider benefit amount for said provider wherein said provider benefit amount is associated with the performance of said adherence activity by said patient;
designating a patient benefit amount for said patient wherein said patient benefit amount is associated with the performance of said adherence activity by said patient;
establishing a provider benefit account that is associated with said provider wherein said provider benefit account is associated with a provider benefit account identifier;
establishing a patient benefit account that is associated with said patient wherein said patient benefit account is associated with a patient benefit account identifier;
verifying the performance of said adherence activity by said patient;
calculating a provider benefit amount for said provider based, at least in part, on the performance of said adherence activity by said patient;
calculating a patient benefit amount for said patient based, at least in part, on the performance of said adherence activity by said patient;
crediting said calculated provider benefit amount to said provider benefit account; and
crediting said calculated patient benefit amount to said patient benefit account.

19. The method of claim 18 wherein verifying the performance of an adherence activity by a patient further comprises:
associating said patient account identifier to an insurance health plan account identifier associated with said patient;
receiving an insurance claim associated with said insurance health plan, wherein said insurance claim includes at least a health plan account identifier, a treatment identifier or a prescription identifier;
determining if said insurance plan account identifier corresponds to an patient benefit account identifier; and,
determining if said treatment identifier or prescription identifier corresponds to an adherence activity.

20. A system for providing an incentive benefit to a provider and a patient for a patient's performance of an adherence activity, the system comprising:
a computer readable medium, the computer readable medium storing computer readable code executable to provide:
means for registering adherence programs from program sponsors, wherein said programs include at least provider eligibility criteria, patient eligibility criteria, patient adherence activity eligibility criteria, criteria for verification of patient adherence activity, and a benefit amount;
means for registering eligible providers;
means for establishing a provider benefit account;
means for registering eligible patients;
means for establishing a patient benefit account;
means for receiving data indicating a patient's performance of an adherence activity;
means for determining if the patient is eligible to receive a benefit, based at least in part on the adherence activity and the adherence program eligibility criteria;
means for determining if the provider is eligible to receive a benefit, based at least in part on the adherence activity and the adherence program eligibility criteria; and
means for crediting a provider benefit account.
